(19) United States
(12) Patent Application Publication
(10) Pub. No.: US 2014/0346125 A1
(43) Pub. Date: Nov. 27, 2014

(54) Desalting Salty Sludge System and Method

(71) Applicants: Robert W. Stiles, JR., Cary, NC (US); Dennis P. DeLong, Raleigh, NC (US); Thomas Losordo, Raleigh, NC (US)

(72) Inventors: Robert W. Stiles, JR., Cary, NC (US); Dennis P. DeLong, Raleigh, NC (US); Thomas Losordo, Raleigh, NC (US)

(21) Appl. No.: 14/212,190

(22) Filed: Mar. 14, 2014

Related U.S. Application Data
(60) Provisional application No. 61/782,067, filed on Mar. 14, 2013.

(51) Int. Cl. C02F 9/00

(52) U.S. Cl. CPC C02F 9/00; C02F 2209/10; C02F 2209/08; C02F 2209/15; C02F 2209/14; C02F 2209/18; C02F 2301/08; C02F 11/004
USPC 210/768; 210/96.1

(57) ABSTRACT

A system and method of desalting salty sludge is provided. The method includes providing a salty sludge; processing the salty sludge to increase its surface area; adding water to the salty sludge to make a sludge slurry and to wash the salty sludge; removing and purifying degraded water from the sludge slurry, and recirculating purified water into the sludge slurry; separating a liquid phase and a solid phase of the sludge slurry and purifying the liquid phase; identifying a salt concentration in the solid phase and comparing the salt concentration to a desired value; and adding water to the solid phase if the salt concentration is greater than the desired value.

### CROSS REFERENCE TO RELATED APPLICATIONS

This application claims the benefit of U.S. Provisional Patent Application No. 61/782,067 filed on Mar. 14, 2013, the entire contents of which are incorporated herein by reference.

### BACKGROUND

With the increasing demand for seafood, commercially-viable aquaculture systems having high volume production and environmental sustainability are needed. A drawback for the marine aquaculture industry is the negative impact on the environment in the form of organic/inorganic pollution of coastal areas associated with decomposition of fish feces and uneaten food mixed with salt water. In response to this concern, there is a trend toward shifting marine fish farming inland to closed recirculating systems in order to reduce the environmental impact.

Most of the closed recirculating aquaculture systems use biological nitrogen removal through nitrification/denitrification processes and mechanical solids removal. In the United States, strict regulations on organic matter discharge have motivated the aquaculture industry to integrate solid waste treatment as part of the aquaculture operation. Such treatment employs flocculation/coagulation processes to reduce sludge volume prior to composting it for land dispersal. Solid waste treatment results in marine and brackish water sludge having a high salinity (i.e., salty sludge), which limits use of the salty sludge as fertilizer. The salty sludge appears to be a source of pollution in landfills and waste outflows.

The salty sludge from recirculating aquaculture systems is primarily organic, composed of suspended matter originating from uneaten feed and fish fecal material. For example, it is estimated that 30% to 40% (w/w) of the fish feed ends up as organic waste. It has been found that an aquaculture facility with a standing fish crop of 100 tons and a daily feeding rate of 2% of fish body weight may produce 220 tons to 290 tons annually of dry organic waste as total suspended solids (TSS). The actual volume of the collected waste after settling may be ten times higher and can reach a volume of 2200 m³ to 2900 m³. Furthermore, it has been calculated that a 100-ton salmon farm releases an amount of nitrogen, phosphorus, and fecal matter roughly equivalent to the nutrient waste in untreated sewage from 20,000, 25,000, and 65,000 people, respectively.

Sludge disposal from saltwater aquaculture facilities remains a challenging task. The high salt concentrations prevent the use of marine sludge for land application or composting, which are the two most common methods for sludge disposal from fresh water aquaculture systems. It is expected that a future shift of net-pen mariculture operations to inland recirculating aquaculture systems will produce high volumes of salted sludge that needs to be treated. Not addressing this problem may result in a future “bottle neck” effect that will prevent the potential growth of marine fish production in inland recirculating systems.

In addition, salty sludge also makes up a large percentage of the waste in the seafood processing industry. Salty sludge, including heads, internal organs, and other undesired parts of the fish, represents a significant environmental hazard in the absence of treatment. On the other hand, after a desalting treatment, sludge that is protein-rich and contains other nutrients would be desirable for many uses, e.g., land application or composting as a fertilizer. Nevertheless, there is yet to be a method or a process that economically and effectively eliminates salt and dissolved solids from salty sludge. Further, during natural disasters such as a tsunami, sea water immerses farm lands, and the soil evolves into salty sludge masses. The high percentage of salt renders these lands infertile for most plants. Therefore, it may be desirable to decrease and even eliminate salt from lands having a high level of salinity by using a simple and economically feasible method and process.

### SUMMARY OF THE INVENTION

Thus, there is a need for economically sustainable and efficient methods and processes of desalting salty sludge so that the sludge is suitable for future uses, e.g., land application and composting as a fertilizer.

In one embodiment, a method of desalting salty sludge is provided. The method includes the steps of providing a salty sludge and processing the salty sludge to increase its surface area. Water is added to the salty sludge to make a sludge slurry and to wash the salty sludge. Degraded water is removed from the sludge slurry and purified. The purified water is recirculated back into the sludge slurry. A liquid phase and a solid phase of the sludge slurry is separated and the liquid phase is purified. A salt concentration in the solid phase is identified and compared to a desired value. Water is added to the solid phase if the salt concentration is greater than the desired value.

In another embodiment, a system for desalting salty sludge is provided. The system for desalting salty sludge includes a water recirculation system including a first pump, a first conduit, a second conduit, a filter, and a second pump, to substantially continuously provide water to the salty sludge. A liquid-solid phase separation system is included and has a third conduit, a third pump, a separation filter, and a fourth conduit that acts as an outlet for desalted sludge. The system for desalting salty sludge further includes a water purification system to purify a liquid phase separated from a solid phase of the salty sludge. The system for desalting salty sludge includes a processing and mixing system to process bulk sludge into small particles and mix the small particles with water, and a measurement system to determine if enough salt has been removed to use the sludge.

### BRIEF DESCRIPTION OF DRAWINGS

FIG. 1 is a schematic diagram of a prior art recirculating marine aquaculture system.

FIG. 2 is a flow chart of a method of desalting salty sludge according to one embodiment of the invention.

FIG. 3 is a flow chart of a method of water recirculation and purification according to one embodiment of the invention.

FIG. 4 is a flow chart of a method of water recirculation and purification according to another embodiment of the invention.

FIG. 5 is a schematic illustration of a sludge desalting system according to one embodiment of the invention.

### DESCRIPTION OF INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

The term “sludge” as used herein refers to the residual, semi-solid material left from industrial wastewater or sewage treatment processes. It can also refer to the settled suspension obtained from conventional drinking water treatment and numerous other industrial processes. The term can also be used as a generic term for precipitated solid matter produced by water, aquaculture, and sewage treatment processes.

The term “salty sludge” is used herein to refer to those sludges having a high concentration of salt. Specifically, a salty sludge comprising uneaten food and fish feces can be obtained from a marine aquaculture recirculation system. A salty sludge comprising undesired parts of fish (e.g., the head and internal organs) can be obtained from the seafood processing industry. A salty sludge comprising soil can be obtained from infertile land after seawater immersion.

In some embodiments, the phrase “desalting salty sludge” refers to methods and processes to eliminate at least about 85%, or at least about 92%, of the salt concentration from the salty sludge.

The disclosure generally provides a method and process of removing salt from salty sludge to form sludge that is viable for use in other applications. The salty sludge may be obtained from any variety of sources including, but not limited to, a recirculating marine aquaculture system, a seafood processing plant, and/or infertile soil after seawater immersion. After undergoing the procedure discussed herein, it is envisioned that the desalted sludge can be suitable for further uses, including land application and composting as a fertilizer.

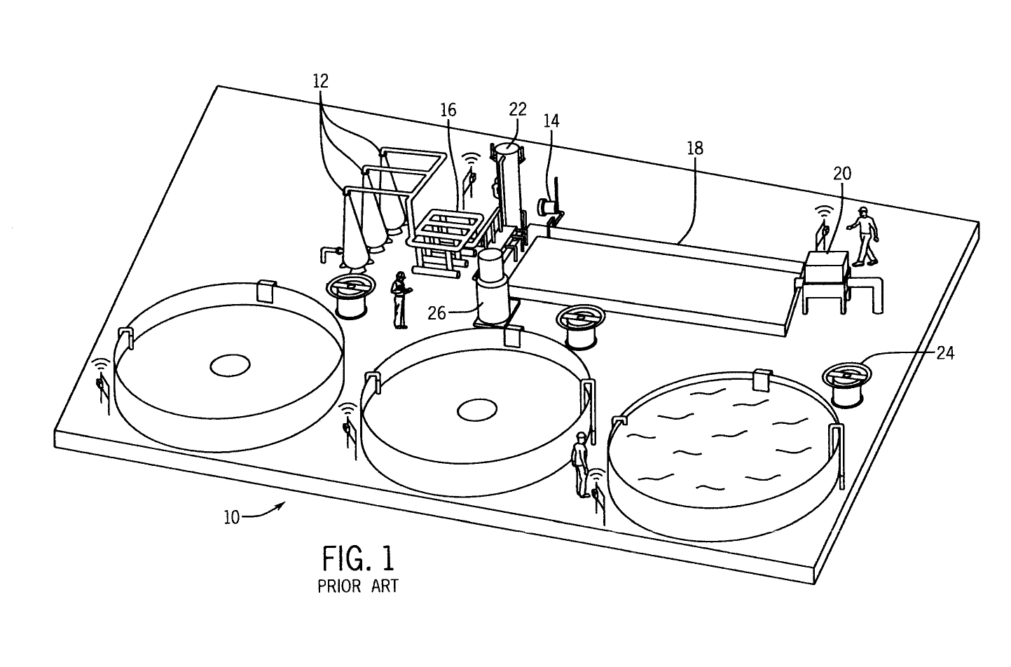

In one embodiment, a method and process is provided for desalting sludge obtained from a recirculating marine aquaculture system. FIG. 1 illustrates a typical recirculating marine aquaculture system 10 that includes one or more oxygen cones/saturators 12, regenerative blowers 14, ultraviolet (UV) sterilizers 16, bioreactors 18, drum filters 20, degassing columns 22, flow setters 24, and protein skimmers 26. The aquaculture system 10 may further include a controller (not shown) designed to control one or more aspects of the system 10. The aquaculture system 10 may include at least one of the aforementioned components, or some components may be omitted. The aquaculture system 10 is designed to hold fish and other aquatic life as the fish are being raised.

The oxygen cones and saturators 12 are provided in the aquaculture system 10 to efficiently optimize gas transfer in water and/or dissolve oxygen within the water. In some embodiments, the oxygen cones and saturators 12 can be compatible with ozone, pure oxygen, and/or other gases. Regenerative blowers 14 may be provided to move a large volume of air and may be designed deliver oil-free air. UV sterilizers 16 may be provided as a disinfectant apparatus and/or agent. More particularly, the UV sterilizers 16 may use ultraviolet radiation for water treatment, or more specifically, microorganism disinfection. The bioreactor 18 may be provided to operate under a low-head moving bed biological reactor concept using bioreactor media for efficient biological filtration. One or more rotating drum filters 20 may be provided for high-volume solids removal. One or more degassing columns 22 can be used for stripping carbon dioxide, nitrogen, hydrogen sulfide, and other volatile gases. The radial flow setter 24 can be used to capture settable solids from a bottom drain of a drain system (e.g., dual drain system), thus dramatically increasing solids removal efficiencies in the recirculating aquaculture system 10. The protein skimmer 26, also referred to as a foam fractionator, can be used to remove dissolved solids, including fine particulates that mechanical filtration does not catch. The dissolved solids are usually proteins that have broken down from wastes, uneaten food, and dead fish. In one embodiment, the salty sludge can be collected primarily by using at least one of the radial flow settler 24 and the protein skimmer 26. In another embodiment, the salty sludge can be collected by using both the radial flow settler 24 and the protein skimmer 26.

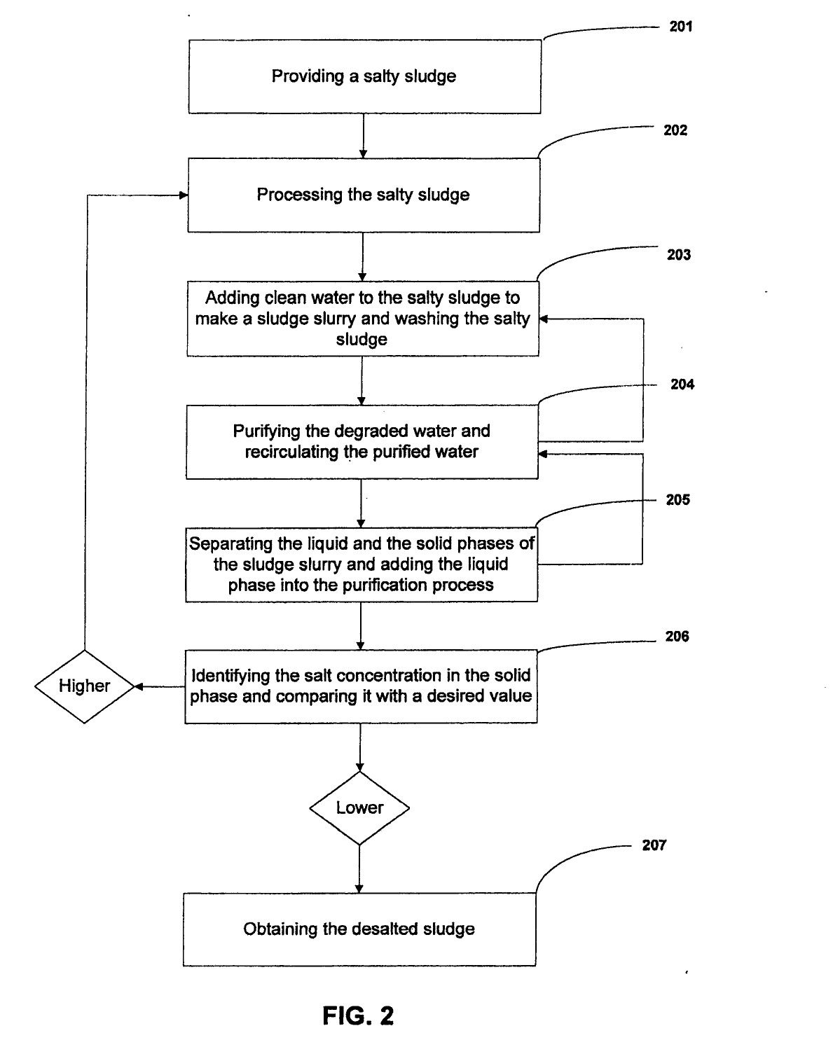

FIG. 2 illustrates a method of desalting salty sludge. As shown in FIG. 2, a quantity of salty sludge is provided at step 201 from the recirculating marine aquaculture system 10. The quantity of salty sludge is typically provided in the form of a large block. The size of the salty sludge is reduced at step 202 by cutting, chopping, and/or slicing the large block of salty sludge into smaller sections, quantities, or particles. The smaller the particles are made, the greater the surface area of the overall salty sludge, which not only improves the solubility of the salty sludge, but also increases the washing efficiency in the subsequent procedures. In one embodiment, the processing step can be combined with a subsequent stirring step using a single machine.

After the salty sludge is reduced, clean water is added into the processed salty sludge particles to form a sludge slurry and the sludge slurry is washed at step 203. A mechanical stirring process can optionally be used to create a uniform colloidal solution of the salty sludge. As the clean water subsequently becomes degraded/dirty water during and/or after the wash process, a substantially continuous supply of clean water may be necessary to effectively eliminate salt from the salty sludge. In one embodiment, a recirculating clean water system can be used. A recirculating clean water system can be applied by filtering or purifying water in a purification process, e.g., by including a water purification system.

As shown in FIG. 2, the degraded/dirty water is purified and the purified water is recirculated back into the system at step 204 after the sludge slurry is washed and produces degraded/dirty water. The degraded/dirty water may be purified by a water purification system, which substantially continuously provides purified water into the washing/desalting system.

After the sludge slurry is made and washed, the liquid and solid phases of the sludge slurry are separated, and the liquid phase is added into the purification process at step 205. In order to measure the salt concentration in the resulting sludge for determination of washing efficiency, the sludge slurry needs to be separated from the salty water. Further, after completely desalting, the resulting sludge needs to solidify for future applications. A suitable method of separation and solidification can include centrifugation, filtration, and other suitable dewatering methods. The liquid phase, including degraded/dirty water, is added into the purification system for further purifying and recirculating.

After phase separation, the salt concentration in the solid phase is identified and compared to a desired concentration at step 206. The salt concentration can be measured with any suitable methods, such as those using flame photometry or Ion-Selective Electrodes.

The desired concentration of salt can be input and stored into the controller, or may be compared to a predefined concentration that has been previously stored in the controller. In some embodiments, the desired concentration of salt can be in the range of 50 mg/L to 800 mg/L. In one embodiment, the desired concentration of salt is in the range of 50 mg/L to 200 mg/L. As shown in FIG. 2, if the as-measured salt concentration is higher than the desired concentration, the sludge will be returned to the procedures of processing at step 202, washing at step 203, and separating at step 205. One or more of the steps 202, 203, 204, 205, 206, 202 can be repeated multiple times until the desired concentration of salt in the sludge is reached. If the as-measured salt concentration is lower than the desired concentration, the desalted sludge is obtained and available for future applications at step 207.

As discussed above, the liquid phase of dirty water can be purified by eliminating at least salt and dissolved solids (DS) and the purified water can be reused at step 205 after phase separation. In one embodiment, a combination system having a water recirculation system and a water purification system are provided. The water recirculation system can substantially continuously wash the salty sludge to decrease, and eventually eliminate, salt from the sludge. The water purification system can substantially continuously provide clean water, or treated water by purifying degraded/dirty water produced in the recirculation system.

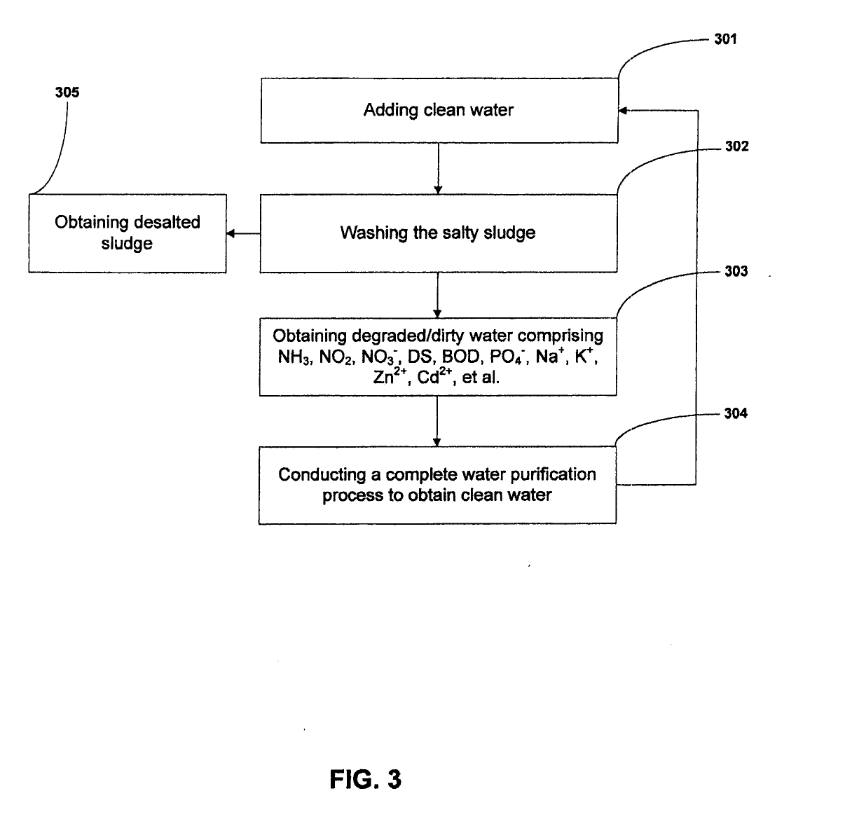

In one embodiment, the water recirculation and purification system can include a one-step complete water purification process. FIG. 3 illustrates a complete water purification process having water recirculation and a purification process in a single step. Clean water is added to the salty sludge at step 301 and the salty sludge is washed at step 302. The step of washing the salty sludge can also include the steps of processing the salty sludge into particles, stirring, and making a sludge slurry to effectively wash the sludge. After the salty sludge is washed, degraded/dirty water is obtained at step 303. In addition to a high concentration of salt (sodium; Na⁺), the degraded/dirty water can also include other waste components such as ammonia (NH₃), nitrogen oxide (NO₂), nitrate(NO₃⁻), dissolved solid (DS), Biochemical Oxygen Demand (BOD), phosphate (PO₄⁻), potassium (K⁺), zinc (Zn²⁺), cadmium (Cd²⁺), and other trace minerals. The degraded/dirty water is then subjected to a complete water purification process at step 304 to fully eliminate salt and all other wastes.

More specifically, within the water purification process, BOD can be removed by using an ozone photolysis treatment. As an unstable molecule, ozone readily releases one atom of oxygen, which provides a powerful oxidizing agent to eliminate most waterborne organisms. In one embodiment, the ozone treatment can be combined with ultraviolet light irradiation. Some elements, such as PO₄⁻ and K⁺, can be removed by using chemical precipitation methods. Further, nitrogen-based wastes including, for example, NH₃ and NO₂, can be removed by using an aerobic biofilter, and NO₃⁻ can be removed by using an anaerobic biofilter or a membrane bioreactor including reverse osmosis (RO) membranes. Salt and dissolved solids (DS) can be substantially fully eliminated following reverse osmosis (RO) using a membrane bioreactor. In some embodiments, salt can be eliminated using an ion-exchange column with zeolite. The resulting clean water can be used in the recirculation system to further wash the salty sludge at step 301. As shown in FIG. 3, one or more of the steps 301, 302, 303, 304, 301 can be repeatedly conducted until a desalting sludge having the desired salt concentration is obtained at step 305.

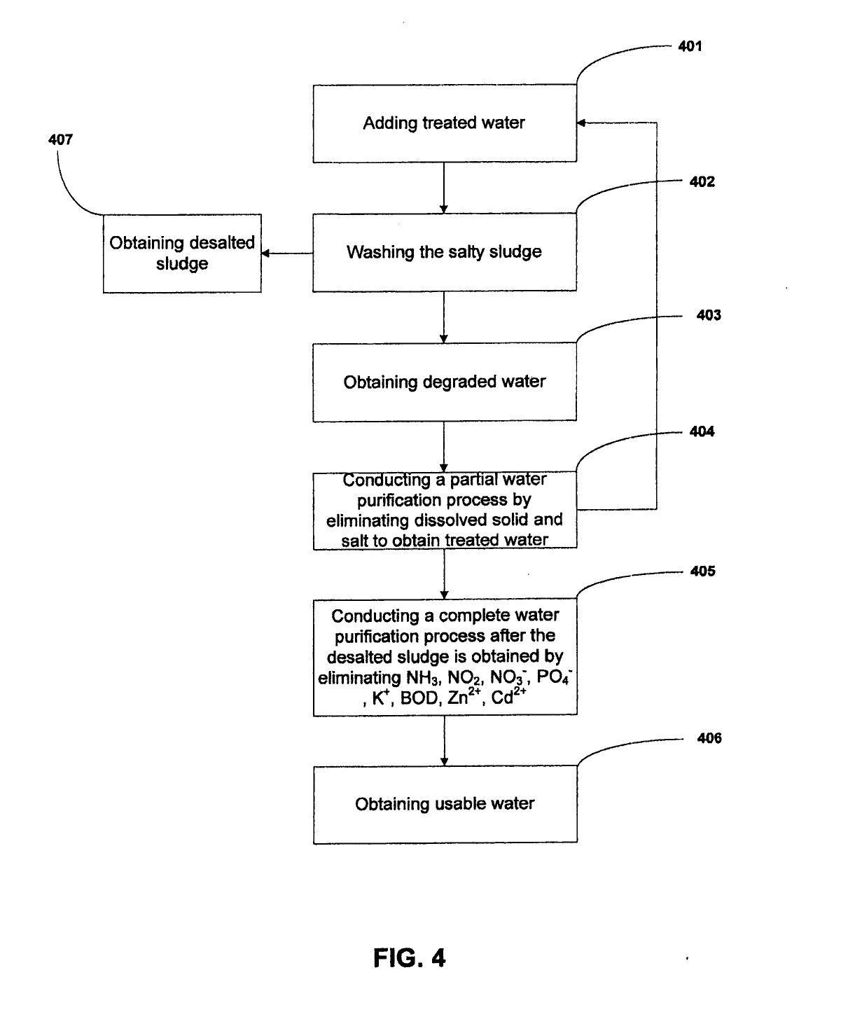

In another embodiment, the water recirculation and purification system can include two steps, including one partial water purification process and one complete water purification process. Despite complete waste removal, a complete water purification process may require a significant amount of energy and resources. FIG. 4 illustrates a water recirculation and purification system including two steps defined by one partial and one complete water purification process. More particularly, treated water is added to the salty sludge at step 401 and the salty sludge is washed at step 402. Degraded/dirty water is subsequently obtained at step 403. At step 404, a partial water purification process is conducted to eliminate dissolved solids (DS) and salt from the degraded water, which are typically the two most undesirable waste components. A single step purification using reverse osmosis (RO) membranes in a membrane bioreactor can be applied to remove both DS and salt during the partial water purification process. The treated water can be used to substantially continuously wash the salty sludge until a sludge having the desired salt concentration is obtained at step 407.

After the sludge is sufficiently desalted, a complete water purification process can be conducted at step 405 to further eliminate other wastes, such as ammonia (NH₃), nitrogen oxide (NO₂), nitrate (NO₃), dissolved solid (DS), Biochemical Oxygen Demand (BOD), phosphate (PO₄), potassium (K⁺), zinc (Zn²⁺), and cadmium (Cd²⁺) (405). These wastes can be eliminated using the same methods discussed above. The resulting water, free of waste, is viable and usable for many applications at step 406. The two-step water purification process described in this embodiment can save additional energy and resources because a complete water purification process is only conducted once instead of multiple times as applied in the previous embodiments of FIGS. 2 and 3.

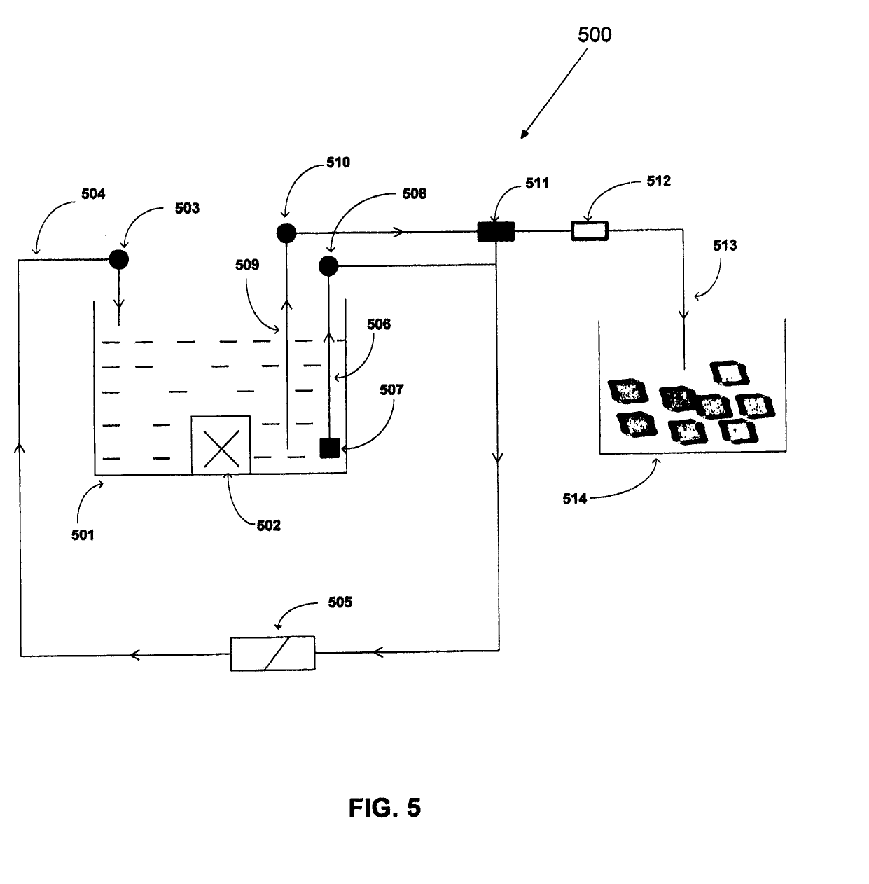

FIG. 5 illustrates a desalting system 500 according to one embodiment. The desalting system 500 can include one or more subsystems including a water recirculation system, a water purification system 505, a processing and mixing system 502, a liquid-solid phase separation system, and a measurement system 512. As shown in FIG. 5, a desalting container 501 can include one or more components of the processing and mixing system 502. After the addition of the initial salty sludge, the processing and mixing system 502 can process bulk sludge into small particles by chopping, slicing, cutting, and/or stirring, as discussed above. Due to its increased overall surface area, the sludge particulate will enable an effective mixing process and thus an efficient washing process. The processing and mixing system 502 can also be used to effectively mix sludge particles and water throughout the desalting process.

In one embodiment, the water recirculation system can include a first pump 503 and a first conduit 504, the water purification system 505, a second conduit 506, a filter 507, and a second pump 508. Through the first pump 503 and the second pump 504, the treated water from the water purification system 505 may be substantially continuously added into the desalting system 500. The filter 507 prevents the solid phase of the sludge slurry from entering the water recirculation system. Degraded/dirty water is substantially continuously or periodically circulated into the water purification system 505 via the second conduit 506 and the second pump 508.

In one embodiment, the water purification system 505 can eliminate substantially all of the wastes present within the degraded/dirty water including salt (Na⁴), ammonia (NH₃), nitrogen oxide (NO₂), nitrate (NO₃), dissolved solid (DS), Biochemical Oxygen Demand (BOD), phosphate (PO₄), potassium (K⁺), zinc (Zn²⁺), cadmium (Cd²⁺), and other trace minerals. Clean water from the water purification system 505 is substantially continuously or periodically added into the desalting system 500 through the conduit 504 and the pump 503.

In one embodiment, the water purification system 505 can eliminate two undesirable waste components in the form of salt (Na⁺) and dissolved solids (DS). For example, the water purification system 505 can include a single step of reverse osmosis (RO) by using a membrane bioreactor to eliminate salt (Na⁺) and dissolved solids (DS). Treated water, which can include other wastes, is substantially continuously or periodically added into the desalting system 500 through the first conduit 504 and the first pump 503. All the other wastes may be eliminated either after the desalted sludge is obtained, or as desired before the resulting water is released into the environment.

As further shown in FIG. 5, the desalting system 500 can also include a liquid-solid phase separation system. The separation system can include a third conduit 509, a third pump 510, a separation filter 511, and a fourth conduit 513 that acts as the outlet of the desalted sludge. The third pump 510 can have a higher pumping capacity and/or horsepower than the first pump 503 and/or the second pump 508 in order to pump sludge slurry rather than water. The separation filter 511 can effectively separate a liquid phase of degraded/dirty water from a solid phase of sludge. The degraded/dirty water can be added into the water recirculation system for future purification and washing. A measurement system 512 can be present after the separation filter 511 to measure the salt concentration in the solid sludge. Only when a desired salt concentration is achieved, will the desalted sludge be transferred to a container 514 through the fourth conduit 513. The third pump 510 can operate in reverse or a recirculation line can be used, if the measured salt concentration is higher than the desired value, in order to move the sludge back into the system for further washing.

In another embodiment, the measurement system 512 is independent from the phase separation system, and the salt concentration can be measured independently in a suitable manner. Only small amount of the washed sludge sample may be needed for such a measurement. Only after a desired salt concentration is reached will the phase separation process be conducted.

Salty sludge can also be the outcome of fertile soil after the immersion of sea water during a natural disaster such as a tsunami. It remains a significant challenge to recultivate soil that has turned into salty sludge. In one embodiment, a method or a process to recultivate soil that has become salty sludge by eliminating the salt is provided. All the above embodiments can be applied to remove salt from soil.

Another source of salty sludge can include solid wastes from the seafood processing industry. A method or process of reusing waste from the seafood processing industry as fertilizer after the effective removal of the salt is also provided. All the above embodiments can be applied to desalt salty sludges from the seafood processing industry.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method of desalting salty sludge, the method comprising:
providing a salty sludge;
processing the salty sludge to increase its surface area;
adding water to the salty sludge to form a sludge slurry and to wash the salty sludge;
removing and purifying degraded water from the sludge slurry and recirculating purified water into the sludge slurry;
separating a liquid phase and a solid phase of the sludge slurry and purifying the liquid phase;
identifying a salt concentration in the solid phase and comparing the salt concentration to a desired value; and
adding water to the solid phase if the salt concentration is greater than the desired value.

2. The method of claim 1 further comprising the step of obtaining the salty sludge from a marine aquaculture recirculating system.

3. The method of claim 1 further comprising the step of obtaining the salty sludge from one of a seafood processing facility and infertile soil due to sea water immersion.

4. The method of claim 1 further comprising the step of substantially completely eliminating waste in the degraded water.

5. The method of claim 4 further comprising the step of completely eliminating at least one of salt (Na⁺), ammonia (NH₃), nitrogen oxide (NO₂), nitrate (NO₃), dissolved solid (DS), Biochemical Oxygen Demand (BOD), phosphate (PO₄⁻), potassium (⁺), zinc (Zn²⁺), and cadmium (Cd²⁺) from the degraded water.

6. The method of claim 1 further comprising substantially completely eliminating salt (Na⁺) and dissolved solids (DS) from the degraded water.

7. The method of claim 1, wherein the salty sludge is processed by one of cutting, chopping, or slicing.

8. The method of claim 1, wherein the salty sludge comprises at least one of dead fish, fish waste, or uneaten fish food.

9. The method of claim 1, wherein the desired value is a salt concentration in the range of between 50 mg/L to 200 mg/L.

10. The method of claim 1, wherein at least one step of the method is repeated until the salt concentration is less than the desired value.

11. A system for desalting salty sludge, the system comprising:
a water recirculation system comprising a first pump, a first conduit, a second conduit, a filter, and a second pump, to substantially continuously provide water to the salty sludge;
a liquid-solid phase separation system comprising a third conduit, a third pump, a separation filter, and a fourth conduit;
a water purification system to purify a liquid phase separated from a solid phase of the salty sludge;
a processing and mixing system to process the sludge into smaller particles and to mix the small particles with water; and
a measurement system to determine if enough salt has been removed as compared to a desired value.

12. The system of claim 11, wherein the processing and mixing system includes a complete water purification system to eliminate substantially all of the waste from degraded water.

13. The system of claim 12, wherein the waste includes at least one of salt (Na⁺), ammonia (NH₃), nitrogen oxide (NO₂), nitrate (NO₃⁻), dissolved solid (DS), Biochemical Oxygen Demand (BOD), phosphate (PO₄), potassium (K⁺), zinc (Zn²⁺), and cadmium (Cd²⁺).

14. The system of claim 11, wherein the water purification system is designed to eliminate undesirable waste from the degraded water.

15. The system of claim 14, wherein the undesirable waste being removed includes salt (Na⁺) and dissolved solids (DS).

16. The system of claim 11, wherein the measurement system is integrated into the liquid-solid phase separation system.

17. The system of claim 11, wherein the measurement system is independent from the liquid-solid phase separation system.

18. The system of claim 11, wherein the liquid-solid phase separation system includes a filter for separation of a liquid phase of degraded water and solid sludge, and wherein the liquid phase of the degraded water is recirculated into the water recirculation system.

19. The system of claim 11, wherein the desired value is a salt concentration in the range of between 50 mg/L to 200 mg/L.

20. The system of claim 11, wherein the water purification system includes two purification steps in the form of a partial purification step and a complete purification step.
